(19) United States
(12) Patent Application Publication
(10) Pub. No.: US 2003/0099494 A1
(43) Pub. Date: May 29, 2003

(54) Apparatus and method for sensing media in a printing device

(76) Inventor: Steven P. Downing, Camas, WA (US)

Correspondence Address: HEWLETT-PACKARD COMPANY, Intellectual Property Administration, P.O. Box 272400, Fort Collins, CO, 80527-2400, US

(21) Appl. No.: 09/995,900

(22) Filed: Nov. 28, 2001

(51) Int. Cl. B41J 11/42

(52) U.S. Cl. 400/56

(57) ABSTRACT

An apparatus and method are disclosed herein for sensing media in a printing device. Further characteristics and features of the present invention are additionally disclosed herein, as are exemplary alternative embodiments. This abstract is not to be used in the interpretation of any of the claims.

### BACKGROUND AND SUMMARY

The present invention relates to printing devices. More particularly, the present invention relates to an apparatus and method for sensing media in a printing device.

Printing devices, such as inkjet printers and laser printers, use printing composition (e.g., ink or toner) to print images (text, graphics, etc.) onto a print medium advanced through a printzone of the printing device by a print medium transport mechanism. Inkjet printers may use print cartridges, also known as “pens”, which deposit printing composition, referred to generally herein as “ink”, onto a print medium such as paper, labels, forms, transparencies, or fabric as the print medium is advanced through the printzone of the printing device. Each pen has a printhead that includes a plurality of nozzles. Each nozzle has an orifice through which the printing composition is ejected. To print an image, the printhead is propelled back and forth across the print medium by, for example, a carriage while ejecting printing composition in a desired pattern as the printhead moves. The particular ink ejection mechanism within the printhead may take a variety of different forms known to those skilled in the art, such as thermal printhead technology. For thermal printheads, the ink may be a liquid, with dissolved colorants or pigments dispersed in a solvent.

Printing composition should be deposited on print media rather than on unintended printing device components such as the print medium transport mechanism. If printing composition is deposited on such unintended components, they may be damaged and not work properly. Also, once printing composition is deposited on such unintended components, they may inadvertently transfer printing composition onto print media which degrades output print quality and renders the printing device useless until the device is serviced and cleaned. This problem can be avoided by enabling deposition of printing composition only once the beginning or top of a print medium has been detected and disabling deposition of printing composition at a time after the end or bottom of a print medium has been detected. Detection of the end or bottom of a print medium may also signal that other components of the print medium transport mechanism should complete the transport of the print medium through the printing device.

Printing devices are typically designed to advance a single sheet of print media through the printzone at any given time. In fact, if multiple sheets of print media are advanced through the printzone at the same time, damage to the printheads and print media can occur by contact between them. Additionally, attempted advancement of multiple sheets of print media through the printzone at the same time may result in jamming of the print medium transport mechanism. Obviously, this is undesirable in that the print medium and printheads may need to be replaced if damaged which adds to the cost of operation of the printing device. Also, such damage and jamming requires user intervention and reduces the potential throughput of the printing device, both of which are undesirable.

Various thicknesses of print media may be used in a printing device. It is important, however, to maintain sufficient spacing between the printheads and a print medium in the printzone of a printing device. If this sufficient spacing is not maintained, one or more of the printheads may contact the print medium causing possible damage to the print medium and printheads. Obviously, this is undesirable in that the print medium and printheads may need to be replaced which adds to the cost of operation of the printing device. Also, such damage requires user intervention and reduces the potential throughput of the printing device, both of which are undesirable. These undesirable results may be avoided if the thickness of the particular print medium can be determined before that print medium enters the printzone. Once this thickness is determined, the spacing of the printheads from the print medium can be adjusted, if necessary, to avoid contact between them.

Alleviation of these above-described problems would be a welcome improvement. The present invention is directed to helping solve them with the goals of maintaining optimal printing device output print quality, preventing print medium jamming, optimizing printing device throughput, minimizing necessary user intervention, preventing waste of print media, preventing damage to printheads, and preventing damage to other components of the printing device caused by accidental deposition of printing composition on such components.

An embodiment of an apparatus in accordance with the present invention for use in a printing device having a printzone in which printing composition is deposited on a print medium includes a print medium drive mechanism configured to advance the print medium through the printzone. The apparatus also includes a pinch roller mechanism biased against the print medium drive mechanism and configured to deflect away from the print medium drive mechanism as the print medium passes between the pinch roller mechanism and print medium drive mechanism. The apparatus further includes a proximity sensor configured to measure the extent of deflection of the pinch roller mechanism.

The above-described embodiment of an apparatus in accordance with the present invention may be modified and include at least the following characteristics, as described below. The apparatus may further include a processing device coupled to the proximity sensor and configured to determine a thickness of the print medium based on the measured extent of deflection of the pinch roller mechanism. In such cases, the proximity sensor is further configured to output a signal indicative of the extent of deflection of the pinch roller mechanism and the processing device is further configured to receive the signal from the proximity sensor and determine the print medium thickness based on this signal. Also in such cases, the processing device is further configured to enable initial deposition of printing composition on the print medium by the printing device after receiving the signal from the proximity sensor.

The print medium drive mechanism may include a drive roller. The proximity sensor may be positioned adjacent the pinch roller mechanism. Alternatively, the proximity sensor may be integral with the pinch roller mechanism. The apparatus may be used in a printing device.

An alternative embodiment of an apparatus in accordance with the present invention for use in a printing device having a printzone in which printing composition is deposited on a print medium, includes a print medium drive mechanism configured to advance the print medium through the printzone. The apparatus also includes a shim biased against the print medium drive mechanism and configured to deflect away from the print medium drive mechanism as the print medium passes between the shim and print medium drive mechanism. The apparatus further includes a proximity sensor configured to measure the extent of deflection of the shim.

The above-described alternative embodiment of an apparatus in accordance with the present invention may be modified and include at least the following characteristics, as described below. The apparatus may further include a processing device coupled to the proximity sensor and configured to determine a thickness of the print medium based on the measured extent of deflection of the shim. In such cases, the proximity sensor is further configured to output a signal indicative of the extent of deflection of the shim and the processing device is further configured to receive the signal from the proximity sensor and determine the print medium thickness based on this signal. Also in such cases, the processing device is further configured to enable initial deposition of printing composition on the print medium by the printing device after receiving the signal from the proximity sensor.

The print medium drive mechanism may include a drive roller. The proximity sensor may be positioned adjacent the shim. Alternatively, the proximity sensor may be integral with the shim. The apparatus may be used in a printing device.

An embodiment of a method in accordance with the present invention for use in a printing device having a printzone in which printing composition is deposited on a print medium and a print medium transport mechanism through which the print medium passes, includes advancing the print medium through the printzone via the print medium transport mechanism. The method also includes measuring a deflection of a component of the print medium transport mechanism as the print medium passes therethrough. The method further includes determining a thickness of the print medium based on the measured extent of deflection.

The above-described embodiment of a method in accordance with the present invention may be modified and include at least the following characteristics, as described below. The component of the print medium transport mechanism may be a pinch roller. Alternatively, the component of the print medium transport mechanism may be a shim.

The print medium transport mechanism may include a drive roller. The method may further include enabling initial deposition of printing composition on the print medium by the printing device after the print medium passes through the print medium transport mechanism.

Another alternative embodiment of an apparatus in accordance with the present invention for use in a printing device having a printzone in which printing composition is deposited on a print medium, includes structure for advancing the print medium through the printzone. The apparatus also includes sensor structure for generating a signal in proportion to a deflection of a component of the structure for advancing as the print medium passes therethrough. The apparatus further includes structure for determining a thickness of the print medium based on the signal from the sensor means.

The foregoing summary is not intended by the inventors to be an inclusive list of all the aspects, advantages, and features of the present invention, nor should any limitation on the scope of the invention be implied therefrom. This summary is provided in accordance with 37 C.F.R. Section 1.73 and M.P.E.P. Section 608.01(d). Other objects, advantages, and novel features of the present invention will become apparent from the following detailed description when considered in conjunction with the accompanying drawings.

### BRIEF DESCRIPTION OF THE DRAWINGS

FIG. 1 is a view of a printing device that includes an embodiment of the present invention.

FIG. 2 is a diagrammatic view of an embodiment of an apparatus in accordance with the present invention.

FIG. 3 is a diagrammatic view of an alternative embodiment of an apparatus in accordance with the present invention.

FIG. 4 is a diagrammatic view of another alternative embodiment of an apparatus in accordance with the present invention.

FIG. 5 is a diagrammatic view of yet another alternative embodiment of an apparatus in accordance with the present invention.

FIG. 6 is a diagrammatic view of an embodiment of a method in accordance with the present invention.

### DETAILED DESCRIPTION OF THE DRAWINGS

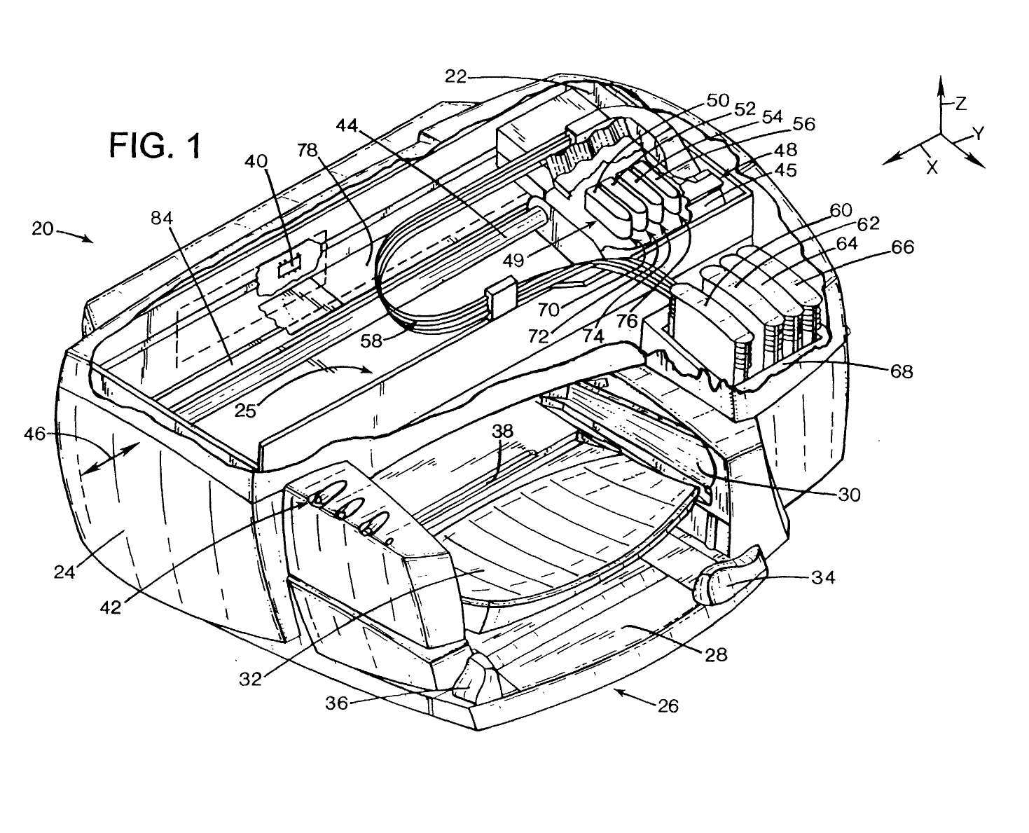

FIG. 1 illustrates an embodiment of a printing device 20, in accordance with the present invention, here shown as an “off-axis” inkjet printer, which may be used for printing business reports, correspondence, desktop publishing, and the like, in an industrial, commercial, office, home or other environment. A variety of inkjet printing devices are available. For example, some of the printing devices that may embody the present invention include plotters, portable printing units, copiers, cameras, video printers, and facsimile machines, to name a few, as well as various combination devices, such as a combination facsimile and printer. In addition, the present invention may be used in a variety of types of printing devices such as inkjet printers and laser printers. For convenience, the concepts of the present invention are illustrated in the environment of an inkjet printer 20 in FIG. 1.

While it is apparent that the printing device components may vary from model to model, the typical inkjet printer 20 includes a frame or chassis 22 surrounded by a housing, casing or enclosure 24, typically made of a plastic material. Sheets of print media are fed through a printzone 25 by a print medium transport mechanism 26. The print media may be any type of suitable material, such as paper, card-stock, transparencies, photographic paper, fabric, mylar, and the like, but for convenience, the illustrated embodiment is described using paper as the print medium. Print medium transport mechanism 26 has an input supply feed tray 28 for storing sheets of print media before printing. Print medium transport mechanism 26 also includes a series of print media drive rollers driven by a motor and drive gear assembly (both of which are not shown in FIG. 1) to move the print media from feed tray 28, through the printzone 25, and, after printing, onto a pair of extendable output drying wing members 30, only one of which is shown in FIG. 1. Wings 30 momentarily hold a newly printed sheet of print media above any previously printed sheets still drying in an output tray portion 32, wings 30 then retract to the sides to drop the newly printed sheet into output tray 32. Print medium transport mechanism 26 may include a series of adjustment mechanisms for accommodating different sizes of print media, including letter, legal, A-4, envelopes, etc., such as a sliding length adjustment lever 34, a sliding width adjustment lever 36, and an envelope feed port 38.

Printing device 20 also has a processing device 40, illustrated schematically as a microprocessor, that receives instructions from a host device, typically a computer, such as a personal computer (not shown). Many of the functions of processing device 40 may be performed by the host computer, by electronics on board printing device 20, or by interactions between the host computer and the electronics. As used herein, the term “processing device 40” encompasses these functions, whether performed by the host computer, printing device 20, an intermediary device between the host computer and printing device 20, or by combined interaction of such elements. Processing device 40 may also operate in response to user inputs provided through a key pad 42 located on the exterior of casing 24. A monitor (not shown) coupled to the computer host (also not shown) may be used to display visual information to an operator, such as printing device 20 status or a particular program being run on the host computer. Personal computers, their input devices, such as a keyboard and/or a mouse device, and monitors are all well known to those skilled in the art.

A carriage guide rod 44 is supported by chassis 22 to slidably support an off-axis inkjet pen carriage system 45 for travel back and forth across printzone 25 along a bi-directional scanning axis 46. As can be seen in FIG. 1, scanning axis 46 is substantially parallel to the X-axis of the XYZ coordinate system shown in FIG. 1. Carriage 45 is also propelled along guide rod 44 into a servicing region, as indicated generally by arrow 48, located within the interior of housing 24. A conventional carriage drive gear and motor assembly (both of which are not shown in FIG. 1) may be coupled to carriage 45, with the motor operating in response to control signals received from processing device 40 to incrementally advance carriage 45 along guide rod 44 in response to movement of the motor.

In printzone 25, a print medium (not shown in FIG. 1) receives printing composition from a print engine 49. Print engine 49 may include a variety of means for depositing printing composition on a print medium, such as black ink cartridge 50 and three monochrome color ink cartridges 52, 54 and 56 shown in FIG. 1. Cartridges 50, 52, 54, and 56 are also often called “pens” by those in the art. Pens 50, 52, 54, and 56 each include small reservoirs for storing a supply of ink in what is known as an “off-axis” ink delivery system, which is in contrast to a replaceable ink cartridge system where each pen has a reservoir that carries the entire ink supply as the cartridge reciprocates over printzone 25 along the scan axis 46. The replaceable ink cartridge system may be considered an “on-axis” system, whereas systems which store the main ink supply at a stationary location remote from the printzone scanning axis are called “off-axis” systems. It should be noted that the present invention is operable in both off-axis and on-axis systems.

In the illustrated off-axis printer 20, ink of each color for each cartridge is delivered via a conduit or tubing system 58 from a group of main stationary ink reservoirs 60, 62, 64, and 66 to the on-board reservoirs of respective pens 50, 52, 54, and 56. Stationary ink reservoirs 60, 62, 64, and 66 are replaceable ink supplies stored in a receptacle 68 supported by printer chassis 22. Each of pens 50, 52, 54, and 56 has a respective printhead, as indicated generally by arrows 70, 72, 74, and 76, which selectively ejects ink to form an image on a print medium in printzone 25.

Printheads 70, 72, 74, and 76 each have an orifice plate with a plurality of nozzles formed therethrough in a manner well known to those skilled in the art. The illustrated printheads 70, 72, 74, and 76 are thermal inkjet printheads, although other types of printheads may be used, such as piezoelectric printheads. Thermal printheads 70, 72, 74, and 76 typically include a plurality of resistors which are associated with the nozzles. Upon energizing a selected resistor, a bubble of gas is formed which ejects a droplet of ink from the nozzle onto a sheet of print media in printzone 25 under the nozzle. The printhead resistors are selectively energized in response to firing command control signals delivered by a multi-conductor strip 78 from processing device 40.

To provide carriage positional feedback information to processing device 40, an encoder 84 extends along the length of printzone 25 and over the service station area 48, with a conventional optical encoder reader (not shown) being mounted on carriage 45 to read positional information provided by encoder 84. Encoder 84 may have a variety of different configurations, including the illustrated substantially rectangular strip configuration shown. Printing device 20 uses encoder 84 and the optical encoder reader to trigger the firing of printheads 70, 72, 74, and 76, as well as to provide feedback for position and velocity of carriage 45. Encoder 84 works with a light source and a light detector (both of which are not shown) of the optical encoder reader. The light source directs light through encoder 84 which is received by the light detector and converted into an electrical signal which is used by processing device 40 of printing device 20 to control firing of printheads 70, 72, 74, and 76, as well as carriage 45 position and velocity. Markings or indicia on encoder 84 periodically block this light from the light detector in a predetermined manner which results in a corresponding change in the electrical signal from the detector. The manner of providing positional feedback information via the optical encoder reader may be accomplished in a variety of different ways known to those skilled in the art.

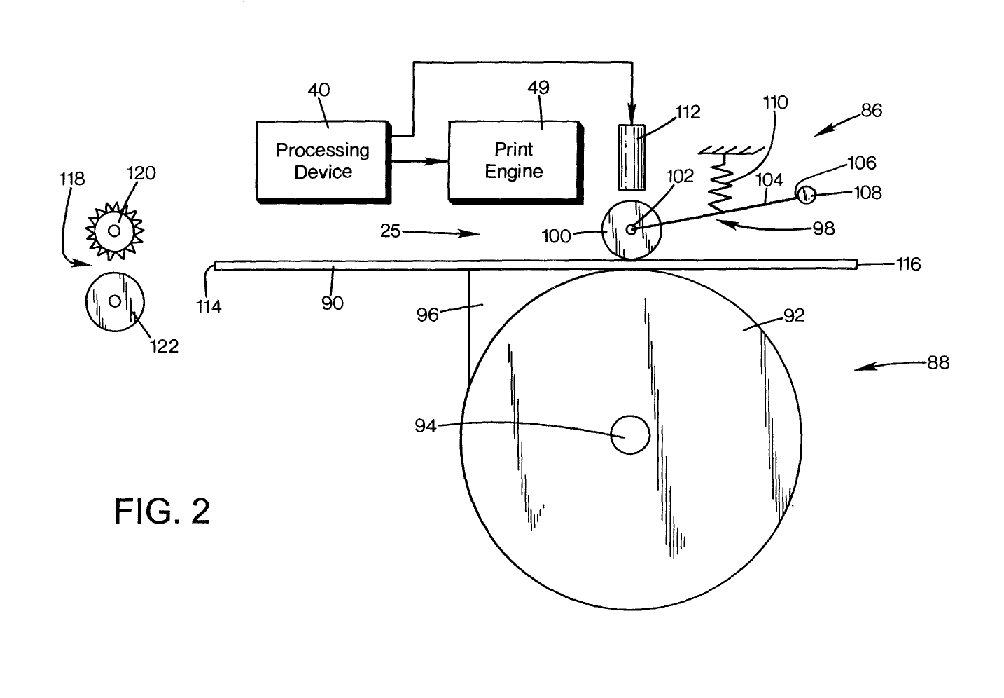

A diagrammatic view of an embodiment of an apparatus for sensing print media 86 in accordance with the present invention is shown in FIG. 2. As can be seen in FIG. 2, apparatus 86 includes a print medium drive mechanism 88 configured to advance a print medium 90 through printzone 25. In the embodiment of apparatus 86 shown in FIG. 2, print medium drive mechanism 88 includes at least one drive roller 92 rotatably driven on a shaft 94. A platen 96 is also shown. Apparatus 86 also includes a pinch roller mechanism 98 that is biased against print medium drive mechanism 88 and configured to deflect away from print medium drive mechanism 88 as print medium 90 passes between pinch roller mechanism 98 and print medium drive mechanism 88. As can be seen in FIG. 2, pinch roller mechanism 98 includes at least one pinch roller 100 rotatably mounted on a first end 102 of arm 104. Second end 106 of arm 104 is pivotally mounted at pivot point 108. A biasing member 110 presses against arm 104 to bias pinch roller mechanism 98 against print medium drive mechanism 88 as discussed above.

As can also be seen in FIG. 2, apparatus 86 also includes a proximity sensor 112 positioned adjacent pinch roller mechanism 98 and configured to measure the extent of deflection of pinch roller mechanism 98 as print medium 90 passes therethrough. In a preferred embodiment of the present invention, proximity sensor 112 is supplied by Keyence under model number AH-305. As can further be seen in FIG. 2, processing device 40 is coupled to proximity sensor 112 so that signals indicative of the measured extent of deflection of pinch roller mechanism 98 generated by proximity sensor 112 are received by processing device 40.

Processing device 40 is configured to determine the thickness of print medium 90 based on the measured extent of deflection of pinch roller mechanism 98. In accordance with the present invention, this thickness measurement is highly accurate because print medium 90 is compressed between drive roller 92 and pinch roller 100 by biasing member 110.

Once the thickness has been determined, processing device 40 is further configured to detect whether a multi-pick of print media has occurred. That is, whether more than one sheet of print media is in printzone 25 at the same time. Printing device 20 is designed to advance a single sheet of print medium 90 through the printzone 25 at any given time. In fact, if multiple sheets of print media are advanced through the printzone 25 at the same time, damage to the printheads 70, 72, 74 and 76 and print media can occur by contact between them. Additionally, attempted advancement of multiple sheets of print media through the printzone 25 at the same time may result in jamming of print medium transport mechanism 26. Obviously, this is undesirable in that the print media and printheads 70, 72, 74 and 76 may need to be replaced if damaged which adds to the cost of operation of printing device 20. Also, such damage and jamming requires user intervention and reduces the potential throughput of printing device 20, both of which are undesirable. In accordance with the present invention, if a multi-pick of print media is detected by processing device 40, operation of printing device 20 is halted and the user alerted so that damage to the print media and printheads 70, 72, 74 and 76 can be avoided.

Various thicknesses of print media may be used in printing device 20. It is important, however, to maintain sufficient spacing between printheads 70, 72, 74 and 76 and print medium 90 in printzone 25 of printing device 20. If this sufficient spacing is not maintained, one or more of printheads 70, 72, 74 and 76 may contact print medium 90 causing possible damage to print medium 90 and printheads 70, 72, 74 and 76. Obviously, this too is undesirable in that the print media and printheads 70, 72, 74 and 76 may need to be replaced which adds to the cost of operation of printing device 20. Also, such damage requires user intervention and reduces the potential throughput of printing device 20, both of which are undesirable. In accordance with one or more embodiments of the present invention, this undesirable result is avoided because processing device 40 is configured to determine the thickness of the particular print medium before that print medium enters the printzone 25. Once this thickness is determined, the spacing of printheads 70, 72, 74 and 76 from print medium is adjusted, if necessary, to avoid contact between print medium 90 and printheads 70, 72, 74 and 76.

Also in accordance with the present invention, print medium thickness is determined regardless of the type of print media because the constant characteristic of deflection is used to determine thickness. Therefore, a variety of types of proximity sensors (e.g., reflective, through-beam, capacitive, inductive, etc.) may be used in the present invention. Additionally, the proximity sensor may be located in a variety of positions as long as the proximity sensor is able to measure deflection from its position.

Printing composition should only be deposited on print medium 90 rather than on unintended printing device components such as print medium drive mechanism 88 and pinch roller mechanism 98 of print medium transport mechanism 26. If printing composition is deposited on such unintended components, they may be damaged and not work properly. Also, once printing composition is deposited on such unintended components, they may inadvertently transfer printing composition onto print medium 90 which degrades output print quality and renders the printing device 20 useless until the device is serviced and cleaned. This problem is avoided, in accordance with the present invention, by enabling deposition of printing composition only once the beginning or top 114 of print medium 90 has been detected and disabling deposition of printing composition at a time after the end or bottom 116 of print medium 90 has been detected.

Also in accordance with the present invention, primary drive of print medium 90 transfers from print medium drive mechanism 88 to bottom of page rollers 118 as end or bottom 116 of print medium 90 is detected. As can be seen in FIG. 2, bottom of page rollers 118 include a starwheel 120 and a gear drive 122.

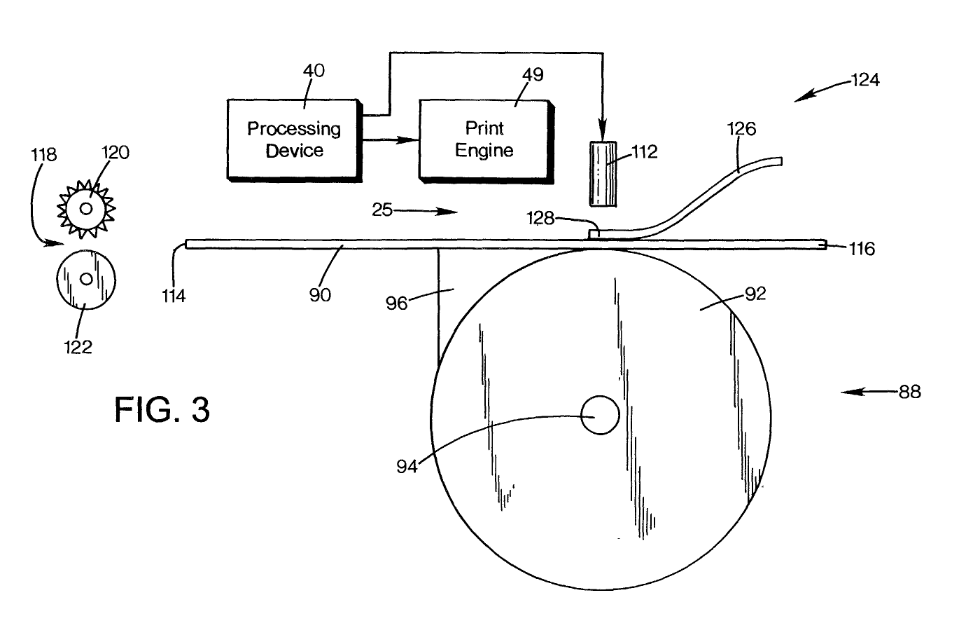

A diagrammatic view of an alternative embodiment of an apparatus for sensing print media 124 in accordance with the present invention is shown in FIG. 3. For convenience, where possible the same reference numerals for identical components of the FIG. 2 embodiment have been used in the FIG. 3 embodiment. As can be seen in FIG. 3, apparatus 124 includes print medium drive mechanism 88 configured to advance a print medium 90 through printzone 25. In the embodiment of apparatus 124 shown in FIG. 3, print medium drive mechanism 88 includes at least one drive roller 92 rotatably driven on a shaft 94. A platen 96 is also shown. Apparatus 124 also includes a shim 126 shaped to have a natural bias against print medium drive mechanism 88 and configured to deflect away from print medium drive mechanism 88 as print medium 90 passes between shim 126 and print medium drive mechanism 88.

As can also be seen in FIG. 3, apparatus 124 also includes proximity sensor 112 positioned adjacent shim 126 and configured to measure the extent of deflection of shim 126 as print medium 90 passes therethrough. As can further be seen in FIG. 3, processing device 40 is coupled to proximity sensor 112 so that signals indicative of the measured extent of deflection of shim 126 generated by proximity sensor 112 are received by processing device 40.

Processing device 40 is configured to determine the thickness of print medium 90 based on the measured extent of deflection of shim 126. In accordance with the present invention, this thickness measurement is highly accurate because print medium 90 is compressed between drive roller 92 and shim 126.

Once the thickness has been determined, processing device 40 is further configured to detect whether a multi-pick of print media has occurred. In accordance with one or more embodiments of the present invention incorporating apparatus 124, processing device 40 is configured to determine the thickness of the particular print medium before that print medium enters the printzone 25. Once this thickness is determined, the spacing of printheads 70, 72, 74 and 76 from print medium is adjusted, if necessary, to avoid contact between print medium 90 and printheads 70, 72, 74 and 76.

Also in accordance with the present invention, thickness is determined regardless of the type of print media because the constant characteristic of deflection is being used to determine thickness. Therefore, a variety of types of proximity sensors (e.g., reflective, through-beam, capacitive, inductive, etc.) may be used in the present invention. Additionally, the proximity sensor may be located in a variety of positions as long as the proximity sensor is able to measure deflection from its position.

Further in accordance with one or more embodiments of the present invention incorporating apparatus 124, deposition of printing composition is enabled only once the beginning or top 114 of print medium 90 has been detected and disabled at a time after the end or bottom 116 of a print medium 90 has been detected. Also in accordance with the present invention, primary drive of print medium 90 transfers from print medium drive mechanism 88 to bottom of page rollers 118 as end or bottom 116 of print medium 90 is detected.

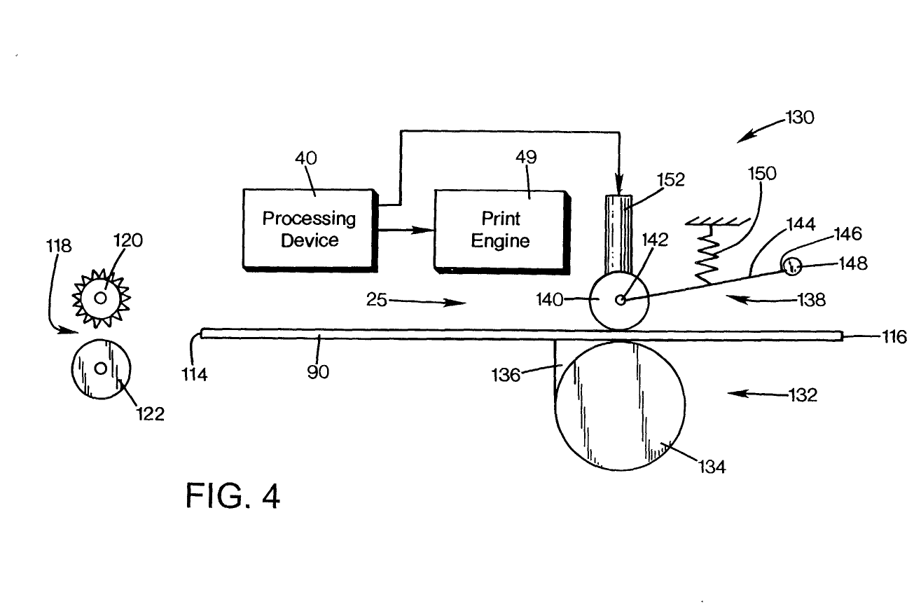

A diagrammatic view of another alternative embodiment of an apparatus for sensing print media 130 in accordance with the present invention is shown in FIG. 4. For convenience, where possible the same reference numerals for identical components of the FIGS. 2 and 3 embodiments have been used in the FIG. 4 embodiment. As can be seen in FIG. 4, apparatus 130 includes print medium drive mechanism 132 configured to advance a print medium 90 through printzone 25. In the embodiment of apparatus 130 shown in FIG. 4, print medium drive mechanism 132 includes a metallic grit roller shaft 134. A platen 136 is also shown. Apparatus 130 also includes a pinch roller mechanism 138 that is biased against print medium drive mechanism 132 and configured to deflect away from print medium drive mechanism 132 as print medium 90 passes between pinch roller mechanism 138 and print medium drive mechanism 132. As can be seen in FIG. 4, pinch roller mechanism 138 includes at least one pinch roller 140 rotatably mounted on a first end 142 of arm 144. Second end 146 of arm 144 is pivotally mounted at pivot point 148. A biasing member 150 presses against arm 144 to bias pinch roller mechanism 138 against print medium drive mechanism 132 as discussed above.

As can also be seen in FIG. 4, apparatus 130 also includes proximity sensor 152 integral with pinch roller mechanism 138 and configured to measure the extent of deflection of pinch roller mechanism 138 as print medium 90 passes therethrough. As can further be seen in FIG. 4, processing device 40 is coupled to proximity sensor 152 so that signals indicative of the measured extent of deflection of pinch roller mechanism 138 generated by proximity sensor 152 are received by processing device 40.

Processing device 40 is configured to determine the thickness of print medium 90 based on the measured extent of deflection of pinch roller mechanism 138. In accordance with the present invention, this thickness measurement is highly accurate because print medium 90 is compressed between metallic grit roller shaft 134 and pinch roller mechanism 138.

Once the thickness has been determined, processing device 40 is further configured to detect whether a multi-pick of print media has occurred. In accordance with one or more embodiments of the present invention incorporating apparatus 130, processing device 40 is configured to determine the thickness of the particular print medium before that print medium enters the printzone 25. Once this thickness is determined, the spacing of printheads 70, 72, 74 and 76 from print medium is adjusted, if necessary, to avoid contact between print medium 90 and printheads 70, 72, 74 and 76.

Also in accordance with the present invention, thickness is determined regardless of the type of print media because the constant characteristic of deflection is being used to determine thickness. Therefore, a variety of types of proximity sensors (e.g., reflective, through-beam, capacitive, inductive, etc.) may be used in the present invention. Additionally, the proximity sensor may be located in a variety of positions as long as the proximity sensor is able to measure deflection from its position.

Further in accordance with one or more embodiments of the present invention incorporating apparatus 130, deposition of printing composition is enabled only once the beginning or top 114 of print medium 90 has been detected and disabled at a time after the end or bottom 116 of a print medium 90 has been detected. Also in accordance with the present invention, primary drive of print medium 90 transfers from print medium drive mechanism 132 to bottom of page rollers 118 as end or bottom 116 of print medium 90 is detected.

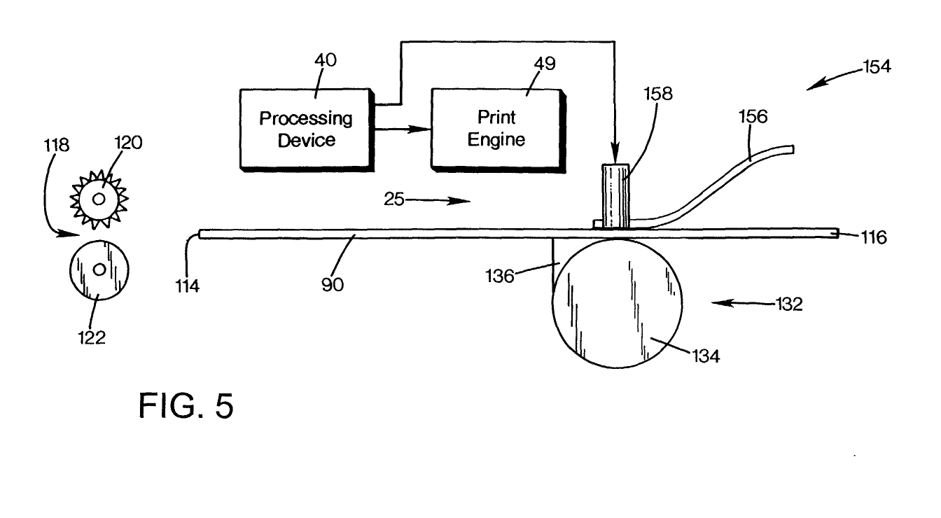

A diagrammatic view of yet another alternative embodiment of an apparatus for sensing print media 154 in accordance with the present invention is shown in FIG. 5. For convenience, where possible the same reference numerals for identical components of the FIG. 4 embodiment have been used in the FIG. 5 embodiment. As can be seen in FIG. 5, apparatus 154 includes print medium drive mechanism 132 configured to advance a print medium 90 through printzone 25. In the embodiment of apparatus 154 shown in FIG. 5, print medium drive mechanism 132 includes a metallic grit roller shaft 134. A platen 136 is also shown. Apparatus 154 also includes a shim 156 that is biased against print medium drive mechanism 132 and configured to deflect away from print medium drive mechanism 132 as print medium 90 passes between shim 156 and print medium drive mechanism 132.

As can also be seen in FIG. 5, apparatus 154 also includes proximity sensor 158 integral with shim 156 and configured to measure the extent of deflection of shim 156 as print medium 90 passes therethrough. As can further be seen in FIG. 5, processing device 40 is coupled to proximity sensor 158 so that signals indicative of the measured extent of deflection of shim 156 generated by proximity sensor 158 are received by processing device 40.

Processing device 40 is configured to determine the thickness of print medium 90 based on the measured extent of deflection of shim 156. In accordance with the present invention, this thickness measurement is highly accurate because print medium 90 is compressed between metallic grit roller shaft 134 and shim 156.

Once the thickness has been determined, processing device 40 is further configured to detect whether a multi-pick of print media has occurred. In accordance with one or more embodiments of the present invention incorporating apparatus 154, processing device 40 is configured to determine the thickness of the particular print medium before that print medium enters the printzone 25. Once this thickness is determined, the spacing of printheads 70, 72, 74 and 76 from print medium is adjusted, if necessary, to avoid contact between print medium 90 and printheads 70, 72, 74 and 76.

Also in accordance with the present invention, thickness is determined regardless of the type of print media because the constant characteristic of deflection is being used to determine thickness. Therefore, a variety of types of proximity sensors (e.g., reflective, through-beam, capacitive, inductive, etc.) may be used in the present invention. Additionally, the proximity sensor may be located in a variety of positions as long as the proximity sensor is able to measure deflection from its position.

Further in accordance with one or more embodiments of the present invention incorporating apparatus 154, deposition of printing composition is enabled only once the beginning or top 114 of print medium 90 has been detected and disabled at a time after the end or bottom 116 of a print medium 90 has been detected. Also in accordance with the present invention, primary drive of print medium 90 transfers from print medium drive mechanism 132 to bottom of page rollers 118 as end or bottom 116 of print medium 90 is detected.

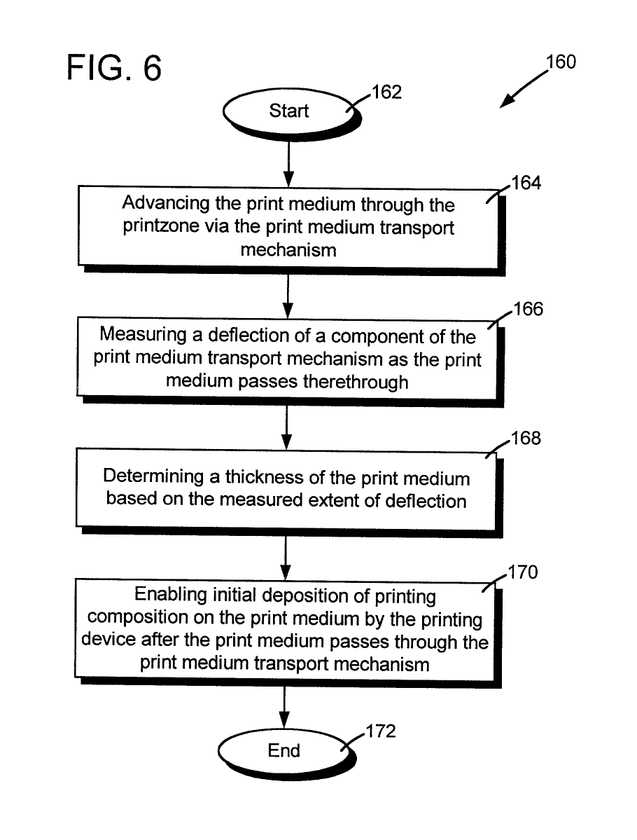

A diagrammatic view of an embodiment of a method 160 for sensing print media in accordance with the present invention is shown in FIG. 6. As can be seen in FIG. 6, method 160 starts 162 by advancing the print medium through the printzone via the print medium transport mechanism 164. Next, method 160 measures a deflection of a component of the print medium transport mechanism as the print medium passes therethrough 166 and determines a thickness of the print medium based on the measured extent of deflection 168. Next, method 160 may enable initial deposition of printing composition on the print medium by the printing device after the print medium passes through the print medium transport mechanism 170. Finally, method 160 ends 172.

Although the invention has been described and illustrated in detail, it is to be clearly understood that the same is intended by way of illustration and example only, and is not to be taken necessarily, unless otherwise stated, as an express limitation, nor is it intended to be exhaustive or to limit the invention to the precise form or to the exemplary embodiments disclosed. Modifications and variations may well be apparent to those skilled in the art. Similarly, any method elements described may be interchangeable with other method elements in order to achieve the same result. The spirit and scope of the present invention are to be limited only by the terms of the following claims.

Reference to an element in the singular is not intended to mean “one and only one” unless explicitly so stated, but rather means “one or more.” Moreover, no element or component in the present specification is intended to be dedicated to the public regardless of whether the element or component is explicitly recited in the following claims. Finally, no claim element herein is to be construed under the provisions of 35 U.S.C. Section 112, sixth paragraph, unless the element is expressly recited using the phrase “means for . . . . ”

What is claimed is:

1. An apparatus for use in a printing device having a printzone in which printing composition is deposited on a print medium, comprising:
a print medium drive mechanism configured to advance the print medium through the printzone;
a pinch roller mechanism biased against the print medium drive mechanism and configured to deflect away from the print medium drive mechanism as the print medium passes between the pinch roller mechanism and print medium drive mechanism; and
a proximity sensor configured to measure the extent of deflection of the pinch roller mechanism.

2. The apparatus of claim 1, further comprising a processing device coupled to the proximity sensor and configured to determine a thickness of the print medium based on the measured extent of deflection of the pinch roller mechanism.

3. The apparatus of claim 2, wherein the proximity sensor is further configured to output a signal indicative of the extent of deflection of the pinch roller mechanism and the processing device is further configured to receive the signal from the proximity sensor and determine the print medium thickness based on this signal.

4. The apparatus of claim 3, wherein the processing device is further configured to enable initial deposition of printing composition on the print medium by the printing device after receiving the signal from the proximity sensor.

5. The apparatus of claim 1, in a printing device.

6. The apparatus of claim 1, wherein the print medium drive mechanism includes a drive roller.

7. The apparatus of claim 1, wherein the proximity sensor is positioned adjacent the pinch roller mechanism.

8. The apparatus of claim 1, wherein the proximity sensor is integral with the pinch roller mechanism.

9. An apparatus for use in a printing device having a printzone in which printing composition is deposited on a print medium, comprising:
a print medium drive mechanism configured to advance the print medium through the printzone;
a shim biased against the print medium drive mechanism and configured to deflect away from the print medium drive mechanism as the print medium passes between the shim and print medium drive mechanism; and
a proximity sensor configured to measure the extent of deflection of the shim.

10. The apparatus of claim 9, further comprising a processing device coupled to the proximity sensor and configured to determine a thickness of the print medium based on the measured extent of deflection of the shim.

11. The apparatus of claim 10, wherein the proximity sensor is further configured to output a signal indicative of the extent of deflection of the shim and the processing device is further configured to receive the signal from the proximity sensor and determine the print medium thickness based on this signal.

12. The apparatus of claim 11, wherein the processing device is further configured to enable initial deposition of printing composition on the print medium by the printing device after receiving the signal from the proximity sensor.

13. The apparatus of claim 9, in a printing device.

14. The apparatus of claim 9, wherein the print medium drive mechanism includes a drive roller.

15. The apparatus of claim 9, wherein the proximity sensor is positioned adjacent the shim.

16. The apparatus of claim 9, wherein the proximity sensor is integral with the shim.

17. A method for use in a printing device having a printzone in which printing composition is deposited on a print medium and a print medium transport mechanism through which the print medium passes, comprising:
advancing the print medium through the printzone via the print medium transport mechanism;
measuring a deflection of a component of the print medium transport mechanism as the print medium passes therethrough; and
determining a thickness of the print medium based on the measured extent of deflection.

18. The method of claim 17, wherein the component of the print medium transport mechanism is a pinch roller.

19. The method of claim 17, wherein the component of the print medium transport mechanism is a shim.

20. The method of claim 17, wherein the print medium transport mechanism includes a drive roller.

21. The method of claim 17, further comprising enabling initial deposition of printing composition on the print medium by the printing device after the print medium passes through the print medium transport mechanism.

22. An apparatus for use in a print device having a printzone in which printing composition is deposited on a print medium, comprising:
means for advancing the print medium through the printzone;
sensor means for generating a signal in proportion to a deflection of a component of the means for advancing as the print medium passes therethrough; and
means for determining a thickness of the print medium based on the signal from the sensor means.

23. The apparatus of claim 22, in a printing device.
